(19) United States
(12) Patent Application Publication
(10) Pub. No.: US 2013/0060679 A1
(43) Pub. Date: Mar. 7, 2013

(54) THIRD-PARTY PAYMENTS FOR ELECTRONIC COMMERCE

(71) Applicants: Ilya Oskolkov, Moscow (RU); Rodion Shishkov, St. Petersburg (RU)

(72) Inventors: Ilya Oskolkov, Moscow (RU); Rodion Shishkov, St. Petersburg (RU)

(73) Assignee: RAWLLIN INTERNATIONAL INC.

(21) Appl. No.: 13/225,890

(22) Filed: Sep. 6, 2011

(51) Int. Cl. G06Q 40/00

(52) U.S. Cl. 705/39

(57) ABSTRACT

Providing for third-party payments for mobile electronic commerce is described herein. By way of example, an electronic transaction initiated at a first subscriber account can be funded at least in part from a second subscriber account. Particularly, the first subscriber account associated with a mobile terminal can select an item for purchase with a content browsing application on the first mobile terminal. A request for payment can be sent from the first mobile terminal to a second mobile terminal, associated with the second subscriber account. Funds transferred from the second mobile terminal to a banking account associated with the first mobile terminal can then be utilized to purchase the item and complete the electronic transaction. In an aspect, information pertaining to respective accounts can be masked from respective subscribers to provide financial privacy in conjunction with third party financing of electronic commerce.

### TECHNICAL FIELD

The subject disclosure relates generally to electronic commerce and more particularly to providing a mobile communications platform that facilitates third party payments for mobile electronic transactions.

### BACKGROUND

Many financial institutions, such as deposit banks, investment banks, and the like, offer online funds management services. These funds management services can vary from institution to institution, but typical examples include online banking, online bill payment, web-based account management functions, and so on. Online funds management is often referred to more generally as online banking.

Online banking has evolved as a consumer service leveraging several recent advancements in electronic networking and electronic communications. At a high level, efficient electronic communications has been a fundamental technology enabling online banking. Content browser applications enable consumers to receive a display of banking information, including account balances, automated payments, transaction history, and the like. A content browser can also incorporate banking functions, like transferring funds, paying a bill, scheduling regular bill payments, and others. Generally speaking, online bill payment provides access to account information and banking functionality anywhere that a computer or other network device can connect to a bank's website.

In addition to account management functionality, online bill payment has been a popular online banking function in recent years. Online bill payment generally involves a consumer logging into an online bank account and signing up to make automatic payments to an account associated with a recipient or payee. A typical recipient can be a merchant or other provider of goods and services. A bank sponsoring the online bank account will carry out the automatic payments from the consumer's online bank account, to the recipient's account. In some cases, the bank may include a list of electronic offerings from which the consumer can search for the recipient's account. If the bank's electronic offerings are static, and the recipient's account is not part of the bank's electronic offerings, electronic payments for the particular recipient may be difficult, however. Moreover, if the recipient's account or related identifying indicia are not known to the consumer, online bill payment may be unavailable for that particular recipient.

The above-mentioned deficiencies of conventional online funds management services and practices are merely intended to provide an overview of some problems of current technology. These deficiencies are not intended to be exhaustive. Other problems with the state of the art, and corresponding benefits of some of the various non-limiting embodiments described herein, may become further apparent upon review of the following detailed description.

### SUMMARY

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

Described herein are systems, methods and articles of manufacture that facilitate third-party payments in electronic commerce. The systems, methods and articles of manufacture described herein can be implemented in connection with any suitable device with an Internet connection, such as a mobile handset, operating in a wireless communication network, a computer, a handheld device, or the like.

In one or more disclosed embodiments, an electronic transaction initiated at a first subscriber account can be funded at least in part from a second subscriber account. Particularly, the first subscriber account associated with a mobile terminal can select an item for purchase with a content browsing application on the first mobile terminal. A request for payment can be sent from the first mobile terminal to a second mobile terminal, associated with the second subscriber account. Funds transferred from the second mobile terminal to a banking account associated with the first mobile terminal can then be utilized to purchase the item and complete the electronic transaction.

In at least one aspect of the subject disclosure, mobile communications related to third party payments can be conducted over a mobile communication network. In this aspect(s), a request for payment and a response to the request can be transmitted via short message service (SMS) messaging, text messaging, multimedia message service (MMS), an e-mail message, a voice call, or the like, or a combination thereof. If payment is approved in response to the request, the mobile communication network can communicate electronically with a financial institution network(s) to effect transfer of funds among banking accounts associated with different subscribers of the mobile communication network.

In other aspects of the subject disclosure, mobile communications related to third party payments can be conducted with peer-to-peer wireless communications. A request for third party payment can be sent from a mobile terminal to a second mobile terminal. The second mobile terminal can approve or deny the request, sending a response to the requesting mobile terminal. In one embodiment, if the request is approved, the second mobile terminal can send a message to the mobile terminal that facilitates transfer of an amount of funds from a bank account associated with the second mobile terminal, to a second bank account associated with the requesting mobile terminal. In another embodiment, the second mobile terminal can initiate online funds transfer from the bank account to the second bank account via online banking. In this latter embodiment, the transfer can be conducted via online banking, or with another electronic portal employed by a financial institution sponsoring the bank account.

In still other aspects of the subject disclosure, mobile communications related to third party payments can be conducted at least in part with peer-to-peer wireless communication and at least in part over a mobile communication network. In these aspects, a request for third-party payment or a response to such a request can be sent either peer-to-peer, or over the mobile network (e.g., via SMS, MMS, text message, e-mail, with a voice call, or the like). Account information for conducting a payment transfer (e.g., requesting bank account information, third party bank account information, routing information, exchange information, and so on) can be implemented securely via peer-to-peer communication (e.g., encrypted wireless communication) or securely over the mobile network (e.g., with a virtual private network, public-private key pair, and so on). Preferences for peer-to-peer or for mobile communication can be stored on respective mobile terminals involved in a transaction, and communication related to the third party payments can be conducted in accordance with the respective preferences, where suitable.

According to still other aspects of the subject disclosure, sending a request for third party payment can include transaction information as well as recipient account information. The transaction information can include an item for purchase, price of the item, electronic merchant offering the item, an information link to electronic content pertaining to the item (e.g., audio content, video content, graphics content, text content, etc.), and so on. Recipient account information can include a financial institution sponsoring a bank account associating with a subscriber sending the request, as well as contact or routing information for the financial institution.

In one or more additional aspects of the subject disclosure, third party payments can be conducted while masking financial information of a third party subscriber. This masking can prevent identification of account information (account type, financial institution, etc.) to a requesting subscriber, or to an online merchant. According to these aspects, information disclosed to the requesting subscriber can include simply acceptance or denial of a third party funding request, as well as an amount approved, and an approval/denial notice associated with funds transfer. In these aspects, third party payments can be conducted with a high level of privacy for a third party payer, providing additional security and peace of mind in conjunction with third party payments.

The following description and the annexed drawings set forth in detail certain illustrative aspects of the disclosed subject matter. These aspects are indicative, however, of but a few of the various ways in which the principles of the innovation can be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 depicts a block diagram of an example of third party funding for mobile electronic transactions according to one or more aspects of the subject disclosure.

FIG. 2 illustrates a block diagram of a sample system that facilitates third party electronic funding for electronic commerce according to other aspects.

FIG. 3 depicts a block diagram of an example mobile terminal configured to provide third party payment for electronic transactions.

FIG. 4 illustrates a block diagram of an example mobile terminal configured to request third party payment for electronic transactions.

FIG. 5 depicts a block diagram of an example system that provides network-facilitated third party payments for electronic transactions in further aspects.

FIG. 6 illustrates a block diagram of a sample system that facilitates peer-to-peer communication for third party electronic payment in still other aspects.

FIG. 7 depicts a flowchart of a sample method for providing third party payments for mobile electronic commerce in aspects of the subject disclosure.

FIGS. 8 and 9 illustrate a flowchart of an example method for initiating a third party funding request according to some other aspects.

FIG. 10 depicts a flowchart of an example method for providing third party funding in mobile electronic commerce according to additional aspects.

FIG. 11 illustrates a block diagram of an example mobile handset that can be configured for operation in conjunction with one or more other disclosed aspects.

FIG. 12 depicts a block diagram of a sample wireless communication network that can be operable for facilitating aspects of the disclosed subject matter.

FIG. 13 illustrates a block diagram of a sample electronic computing device that can be implemented in conjunction with still other disclosed aspects.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing the subject innovation.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary”, “demonstrative”, or the like, is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

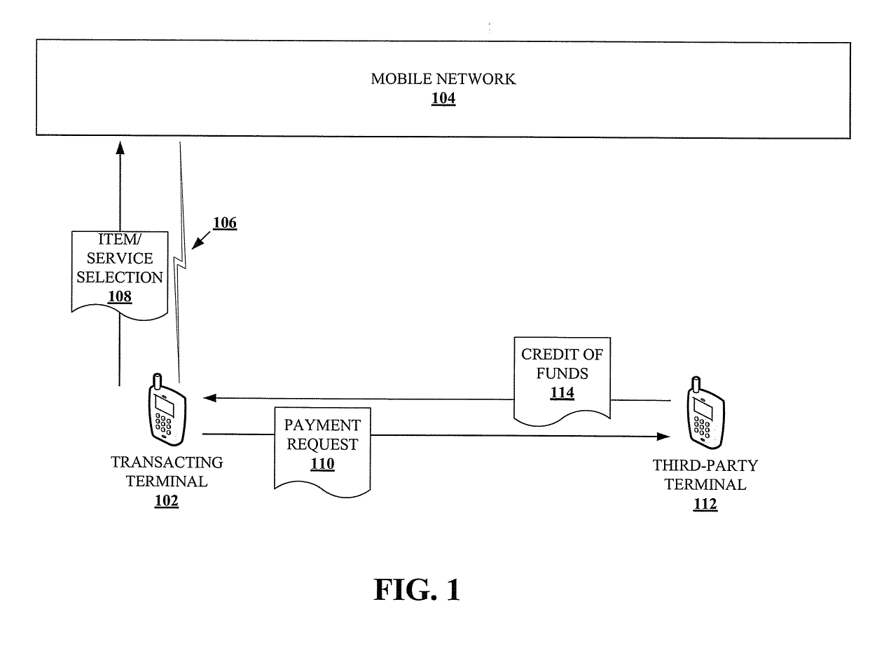

FIG. 1 illustrates a block diagram of a sample system 100 that provides third-party payments for electronic commerce according to aspects of the subject disclosure. A third-party payment, as utilized herein, refers to funding for a transaction that is provided from a financial account of a consumer who does not originate the transaction. The third party, therefore, is not a financial institution that manages or sponsors an account held by a purchaser (purchaser account), and that draws from the account to make payments on behalf of the purchaser. Rather, the third party as utilized herein is an entity having a separate, third-party financial account (which also can be managed or sponsored by a financial institution) from which funds can be drawn to at least in part pay for transactions initiated by the purchaser. According to a particular aspect, funds can be drawn from the third-party account and credited to the purchaser account to facilitate payment for the transaction initiated by the purchaser.

System 100 depicts an example of third-party payments in conjunction with mobile electronic commerce. Mobile electronic commerce involves commerce conducted with one or more mobile communication or computing devices as a means of communication between a merchant entity and a purchaser entity. Suitable mobile communication/computing devices can include, e.g., a cell phone, smart phone, personal digital assistant, laptop computer, and so on, which are capable of wireless communication at least in part over a mobile communication network (e.g., a cellular network, a WiFi network, a WiMAX network, etc.).

System 100 comprises an example of mobile electronic commerce. A transacting mobile terminal 102 is communicatively connected to a mobile network 104 over a wireless link 106. Transacting terminal 102 typically has a subscriber account provided and maintained by an operator of mobile network 104. This subscriber account is a typical vehicle through which communication services are consumed by transacting terminal 102 and through which the operator charges for consumption of such services. Additionally, specific wireless services, subscriber preferences, consumption history, billing history, and other functions associated with subscriber activity can be tracked through the subscriber account. A subscriber account is also referred to herein as a subscriber profile, and may be used in place of a subscriber or user of transacting terminal 102, while incorporating all activity conducted by the subscriber or user on transacting terminal 102 (e.g., an electronic transaction).

Transacting terminal 102 can initiate a transaction with an entity that is also directly or indirectly communicatively connected to mobile network 104. For instance, mobile network 104 can establish an Internet connection for transacting terminal 102, over which transacting terminal 102 can visit a website offering one or more goods or services for sale. In another example, transacting terminal 102 could access a merchant server connected to mobile network 104 either directly, or via some other suitable network other than the Internet (e.g., a private intranet, corporate network, government network, and so on). The term online merchant is utilized herein to refer to any suitable entity that offers sale of goods or services over mobile network 104, or a network directly or indirectly connected to mobile network 104.

Upon establishing a connection with an online merchant, transacting terminal 102 can select an item or service and transmit the item/service selection 108 to the online merchant via wireless link 106 with mobile network 104. In addition, transacting terminal 102 can generate a request for third-party payment 110, for funding payment of the item or service. Request for third-party payment 110 can include information identifying transacting terminal 102 or a subscriber profile making the request, information pertaining to a transaction underlying the request for third-party payment 110, or the like. Identifying information can include a subscriber or user name associated with the subscriber profile, which can be a real name or an alias, as well as information identifying a financial account associated with the subscriber profile or with transacting terminal 102. Transaction information can include a requested amount of funds, information pertaining to the item/service selection 108, or information pertaining to the online merchant, and so on. Additionally, request for third-party payment 110 can include one or more links, such as hypertext markup language (HTML) links, to facilitate acquiring more information pertaining to the transaction, the online merchant, the item selected, or the requesting subscriber profile.

As will be described in more detail herein, request for third-party payment 110 can be sent to a third-party terminal 112 over mobile network 104, or directly through peer-to-peer communication. If third-party terminal 112 approves the request, a credit of funds 114 can be transmitted back to transacting terminal 102 by a similar route, or a different route. Credit of funds 114 can be a notice of credit, that is credited to a financial account associated with transacting terminal 102 by another entity, or can be an actual credit that includes account information and an amount that can be forwarded to a financial institution associated with third-party terminal 112 or a subscriber profile thereof. Credit of funds 114 can be deposited to a financial account associated with transacting terminal 102 or with a subscriber profile associated there with, and used for payment of the electronic transaction described above.

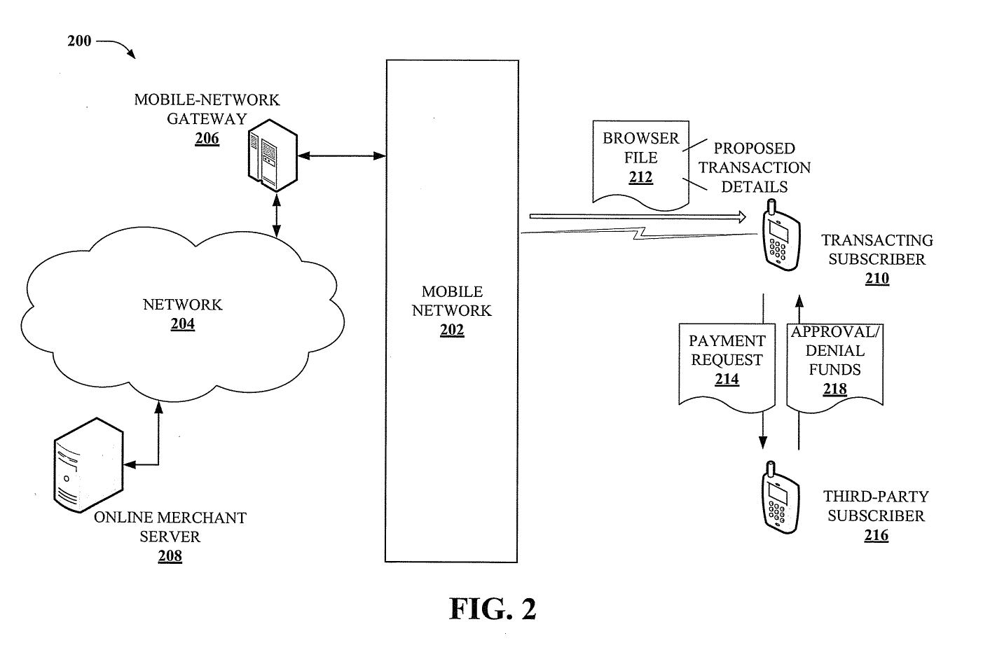

FIG. 2 illustrates a block diagram of an example networking system 200 configured to facilitate third party funding for electronic commerce according to additional aspects of the subject disclosure. Networking system 200 can comprise a mobile network 202 providing wireless communication services to a population of mobile terminals having respective subscriber accounts. Voice, text, multimedia and other communication among the mobile terminals can be facilitated directly by mobile network 202. In addition, mobile network 202 can facilitate communication with other networks, other mobile network subscribers, and so on, via a set of mobile-network gateways 206.

Mobile network gateway 206 can include any suitable entity enabling electronic communication between mobile network 202 and another network 204. Network 204 can include the public circuit-switched telephone network, the Internet and world-wide-web, a private intranet, as well as other mobile networks (e.g., code division multiple access (CDMA) networks, global system for mobile communication (GSM) networks, universal mobile telecommunication system (UMTS) networks, high speed packet access (HSPA) networks, third generation partnership project long term evolution (3GPP LTE) networks, worldwide interoperability for microwave access (WiMAX) networks, WiFi networks, and so on), or the like, or suitable combinations thereof. As an example, network 204 can include the Internet, in which case mobile-network gateway 206 can comprise any suitable gateway configured to convert packet data protocol (PDP) Internet communication into mobile network protocol communication, and vice versa. For the general packet radio service (GPRS) core network employing GPRS tunneling protocol (GTP), mobile-network gateway 206 can comprise a gateway GPRS support node (GGSN). For the LTE network, mobile-network gateway 206 can comprise a packet data network (PDN) gateway, or PGW, and so on for other mobile core networks.

Network 204 can be communicatively connected to one or more online merchant servers 208. Online merchant server 208 facilitates electronic commerce with suitable entities connected to network 204, including mobile network 202 and the population of mobile terminals connected thereto. Online merchant server 208 can include an Internet server configured to advertise and sell products or services, and configured to communicate with a financial institution (not depicted) to facilitate payments related to the sale of those products or services.

A transacting subscriber terminal 210 connected to mobile network 202 can access online merchant server 208 through mobile network 202, via mobile-network gateway 206 and network 204 (e.g., the Internet). A common software application for accessing network content is a content browsing application (e.g., an Internet browser). Such applications are commonly loaded onto mobile terminals, and can facilitate communication with online merchant server 208, as well as initiation of an online transaction with online merchant server 208. In response to initiation of the online transaction, transacting subscriber 210 can receive a browser file 212 including details of the proposed transaction, such as an item or service selected for purchase, and a payment amount required to complete the purchase. Browser file 212 can be in the form of an electronic shopping cart application facilitated by online merchant server, or can be a local shopping cart facilitated by the browsing application of transacting subscriber 210, or the like.

Additionally, the browsing application can enable transacting subscriber 210 to select one or more third party payment sources. Such sources can be stored on a data store (not depicted) of transacting subscriber terminal 210. In one example, third party payment sources can be selected from a “my contacts” list stored on transacting subscriber terminal 210. The “my contacts” list can include subscriber profiles and contact information (e.g., e-mail address, mobile phone number, landline phone number, Internet chat address, etc.) for various other subscribers of mobile network 202, or other individuals. One or more of these subscriber profiles can be established as a third-party payment subscriber. In another example, a separate list of third-party payment subscribers can be maintained and browsed from transacting subscriber terminal 210.

A third-party payment subscriber can be implemented in one of several ways. As one example, a subscriber profile stored at transacting subscriber terminal 210 can simply be flagged as a third-party payer. Upon initiating a transaction with online merchant server 208 and receiving proposed transaction details in browser file 212, such a subscriber profile flagged as a third-party payer can simply be selected, and a payment request 214 forwarded to a third-party subscriber terminal 216 associated with the selected third-party payer profile. In this case, payment request 214 can include information identifying a subscriber account associated with transacting subscriber terminal 210. This information can be utilized by third-party subscriber terminal 216 in crediting an amount of funds to the subscriber account in response to payment request 214.

In another example, a subscriber profile can be compiled having information pertaining to a third-party account associated with the third-party subscriber. In this case, a payment request 214 can be sent to third-party subscriber terminal 216 requesting authorization to debit funds from the third-party account, and credit those funds to the subscriber account associated with transacting subscriber terminal 210, or used to directly fund the electronic transaction. In this example, upon receiving a response from third-party subscriber terminal 216 approving transfer of funds, information from an approval message 218 can be forwarded to a financial institution (not depicted) associated with third-party subscriber terminal 216 to facilitate transfer of an agreed-upon amount of funds from the third-party account to the subscriber account.

In yet another example, payment request 214 can include a schedule for recurring payments. The recurring payments can include, for instance, monthly utility payments, period credit card payments, or some other recurring payment transaction. If the recurring payment request 214 is approved, third-party subscriber 216 can authorize period payments from the third-party account associated with third-party subscriber terminal 216 to the subscriber account associated with transacting subscriber terminal 210. Periodic withdrawal notices can be sent in lieu of subsequent payment requests 214, indicating that a recurring scheduled payment will be withdrawn from the third-party account to the subscriber account for payment to online merchant server 208.

To reject a payment request 214, third-party subscriber terminal 216 sends a denial of funds message 218. Denial of funds message 218 can be utilized to reject a one-time payment request 214, or to alter or terminate the periodic transfer of funds from the third-party account to the subscriber account associated with period payments. Denial of funds message 218 can also be sent to a financial institution managing or sponsoring the third-party account notifying the financial institution not to proceed with payment or further payment, or a manner in which payment should be altered. Likewise, a similar message could be sent to a financial institution sponsoring the subscriber account notifying such institution of the termination or alteration of transfer of funds.

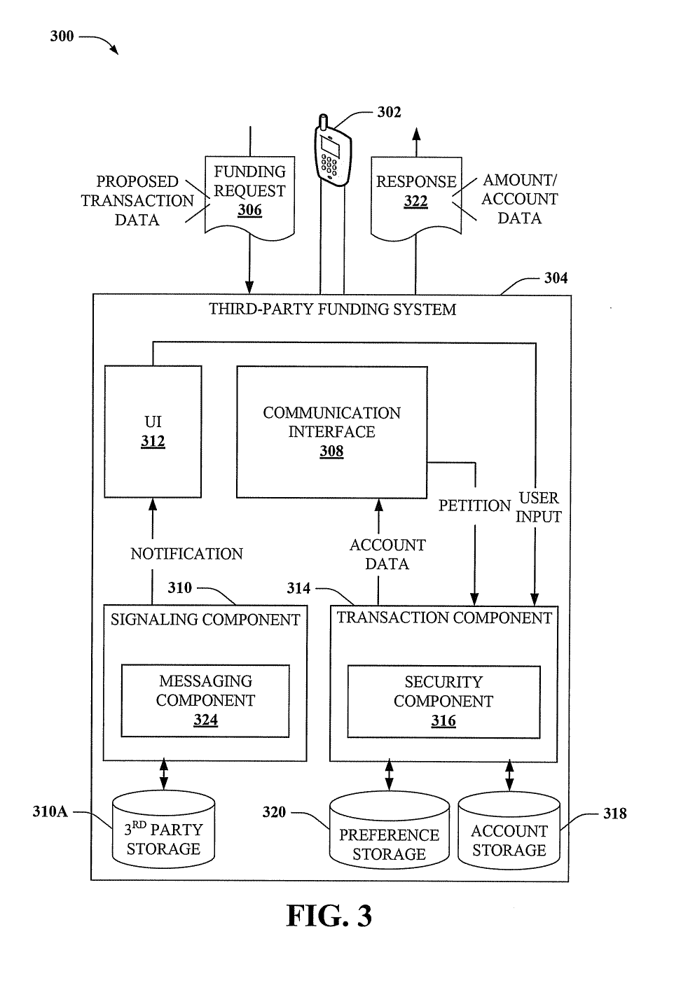

FIG. 3 illustrates a block diagram of an example system 300 configured to facilitate third party funding in mobile electronic commerce according to still other aspects of the subject disclosure. System 300 can comprise a mobile terminal 302 configured with a third-party funding system 304. Third-party funding system 304 can be implemented in hardware, software, or firmware, or a suitable combination thereof. In addition, third-party funding system 304 can be modular, having different functions implemented by different components that interact among themselves. Updates to these functions can be implemented independent of, or in conjunction with, related functions, via software/firmware update, hardware update, or the like, or a combination thereof.

In operation, mobile terminal 302 can receive a funding request message 306 comprising proposed transaction details originated at a requesting subscriber profile (e.g., a requesting mobile terminal—not depicted, but see transacting subscriber terminal 210 of FIG. 2, infra). A communication interface 308 can be configured to receive funding request 306 from mobile terminal 302 and to extract information about a desired electronic transaction from funding request 306, as well as a petition for funding associated with the electronic transaction. Particularly, the petition for funding can be directed to a third-party subscriber profile associated with mobile terminal 302.

A signaling component 310 can be configured to notify the third party subscriber profile of the funding request. The notification can be provided, for instance, to a user interface (UI) 312 to be output to a subscriber or user of mobile terminal 302. Output can be in the form of a message notification (e.g., text message, voice message, SMS message, MMS message, e-mail message, or the like), a graphic notification (e.g., a picture), a video notification, an audio notification (e.g., beep, music clip, voice clip, etc.), or the like, or a suitable combination thereof. The output can also provide at least some indication or information about the desired electronic transaction, as well as the petition extracted by communication interface 308. In at least one aspect, the output can further comprise a link to an online merchant providing an item selected with the desired electronic transaction, such as a website link, an online shopping cart application link, and so on. In an additional aspect, the output can include information (or a link to information) from a third party transaction history storage 310A, which can be employed by third-party funding system 304 to compile information about previous funding requests 306, responses to such requests, as well as payment transactions associated with those requests and responses. Accordingly, a subscriber can view prior transaction history information, as well as information pertaining to a current transaction request, in conjunction with receiving the funding request 306.

A user input accepting, rejecting or considering funding request 306 can be received at UI component 312 and forwarded to a transaction component 314. Additionally, signaling component 310 can be configured to transmit a response 322 indicating a status of the user input to a requesting subscriber terminal. If user input includes rejecting funding request 306, this rejection can be included in response 322. If user input includes considering funding request 306, signaling component 310 can be configured to respond to funding request 306 indicating that the petition is being considered. Optionally, signaling component 310 can also transmit the status of the user input to a merchant account associated with the electronic transaction. Merchant account information can be extracted from funding request 306, where applicable, or obtained from a link to merchant website (e.g., an e-mail address or other contact information specified on the merchant website).

Transaction component 314 can be configured to respond to the user input, and in accordance with user preferences stored in preference storage 320. If user input includes accepting funding request 306, transaction component 314 can be configured to facilitate transfer of funds from a third-party account to a recipient account (e.g., a requesting account associated with a requesting subscriber terminal, or a subscriber thereof). In one embodiment, transaction component 314 can be configured to facilitate selection of a third-party funding account stored on mobile terminal 302. The third-party funding account can be associated directly with mobile terminal 302, e.g., a mobile banking account provided through or in conjunction with a mobile network subscriber, or can be an external banking account provided by a bank, such as a checking account (e.g., referenced by check number, institution number and routing number), a debit card (e.g., referenced by card number, expiration date and security code), a credit account (e.g., referenced by account number and security code), a credit card (e.g., referenced by credit card number, expiration date and security code), or the like, or a suitable combination of such accounts. Distinguishing information pertaining to respective accounts can be stored in an account storage 318, and displayed at UI component 312. An account selected by user input can be utilized as a source to attempt to withdraw an amount of funds specified by the user input.

In at least one embodiment, transaction component 314 can further comprise a security component 316 that can be configured to mask account information stored in account storage 318. Security component 316 can also be configured to require user verification on mobile terminal 302 to access data stored in account storage 318. User verification can include account name and password, security code, biometric identification, or the like, or a combination thereof. Upon successful user verification, security component 316 can allow transaction component 314 to display data stored in account storage 318 on a user interface of mobile terminal 302.

Additionally, security component 316 can be configured to provide proxy information instead of account information, thereby masking third-party account information stored in account storage 318. For instance, respective financial accounts stored on account storage 318 can be referenced by an alias or other identification proxy that does not specify or fully specify a type of account, a banking institution sponsoring or managing the account, a name of a subscriber funding the account, and so on. Proxy information can simply be “account number 1”, “account number 2”, or similar non-descriptive or partially descriptive naming convention. In addition, security component 316 can provide non-descriptive account information for a response 322 to funding request 306, indicating only an approval or denial of funding request 306, and an amount, while excluding information pertaining to what account the amount is withdrawn in response 322. Thus, response 322 might simply include the message “your third-party payment request is approved—500 dollars will be transferred to your mobile device account”, or “recurring payment of 150 dollars will be transferred to your mobile device account”, and so on. Additionally, security component 316 can be configured to disclose data from account storage 318 only to suitable financial institutions involved in actual transfer of funds from respective accounts. As a particular example, security component 316 can require receipt and verification of a suitable digital certificate of an associated financial institution, as a condition to releasing account data in conjunction with transferring funds.

According to various other aspects of the subject disclosure, transaction component 314 can be configured with additional features related to third party funding of electronic payments. In one aspect, transaction component 314 can be configured to receive user input identifying an external account and an amount of funds for third-party payments. For instance, user input can be employed to specify the amount of funds to be provided in response to funding request 306, as well as account information from which the amount of funds are to be withdrawn (e.g., credit card information, checking account information, etc.). Transaction component 314 can be configured to communicate electronically with an entity sponsoring or managing the funding account, and to acquire the amount of funds, a payment assurance for the amount of funds, or a denial of payment of the amount of funds from the entity. A notice of acquisition, payment assurance or denial can be output to UI 312, and can optionally be sent in response 322 to a requesting subscriber terminal or a merchant account.

In at least one further aspect, transaction component 314 can be configured to facilitate a transfer of funds to a requesting subscriber account. In the event a funds transfer is approved from an entity sponsoring a third-party subscriber account, transaction component 316 can extract information identifying the requesting subscriber account and provide that information to the entity sponsoring the third-party subscriber account. Verification of funds transfer can be received by transaction component 314 and included in output to UI 312, as well as in response 322 sent to the requesting subscriber terminal. Contact with the entity sponsoring the third-party subscriber account can be effectuated over a mobile network and a financial network associated with the entity. Communication with the requesting subscriber terminal, including receipt of funding request 306 and transmission of response 322 can be over the mobile network, or conducted via peer-to-peer communication with the requesting subscriber terminal.

In one alternative aspect of the subject disclosure, transaction component 314 can implement a transfer of funds from the third-party subscriber account to requesting subscriber account by providing account information pertaining to the third-party subscriber account, and an amount of funds to transfer, within response 322. This can enable the requesting subscriber terminal to then perform the communication necessary to transfer the amount of funds. In this aspect, security component 316 can be employed to encrypt response 322, to mitigate or prevent interception of response 322. Additionally, security component 316 can be employed to verify security information of the requesting subscriber terminal, such as a digital certificate, or the like, to mitigate or prevent spoofing of the requesting subscriber terminal.

In a further aspect, transaction component 314 can be configured to acquire recipient account information to enable a subscriber of mobile terminal 302 to select an account to which funds are to be transferred in response to funding request 306. In this case, transaction component 314 can display via UI component 312 a list of recipient accounts, for instance. A target account can be selected over the user interface, and the target account selection recorded by transaction component 314 in third-party history storage 310A. Transaction component 314 can be further configured to restrict transfer of the funds to a recipient account other than the target account.

According to another embodiment, third-party funding system 304 can comprise a messaging component 324 configured to exchange user messages between mobile terminal 302 and a requesting mobile terminal in conjunction with funding request 306. For instance, messaging component 324 can be configured to receive a text message, SMS message, MMS message, or the like, from a requesting subscriber terminal. This messaging can be displayed at UI component 312. Content of a received message can include text content, voice content, audio content, video content, graphical content, and so on. Examples can include a text message explaining a desired transaction, a voice message explaining a petition for the third-party payment request 306, and so on. Additionally, messaging component 324 can be configured to exchange a set of messages pertaining to funding request 306 between the requesting terminal and mobile terminal 302, and store the exchanged messages in third party history storage 310A. Thus, messaging component 324 can record a history of communication related to respective funding requests 306. It should be appreciated that messaging component 324 can leverage mobile network signaling as well as peer-to-peer signaling in exchanging messages with the requesting subscriber terminal, in a similar manner that funding request 306 and response 322 can be received and transmitted, respectively, via mobile network signaling or peer-to-peer signaling.

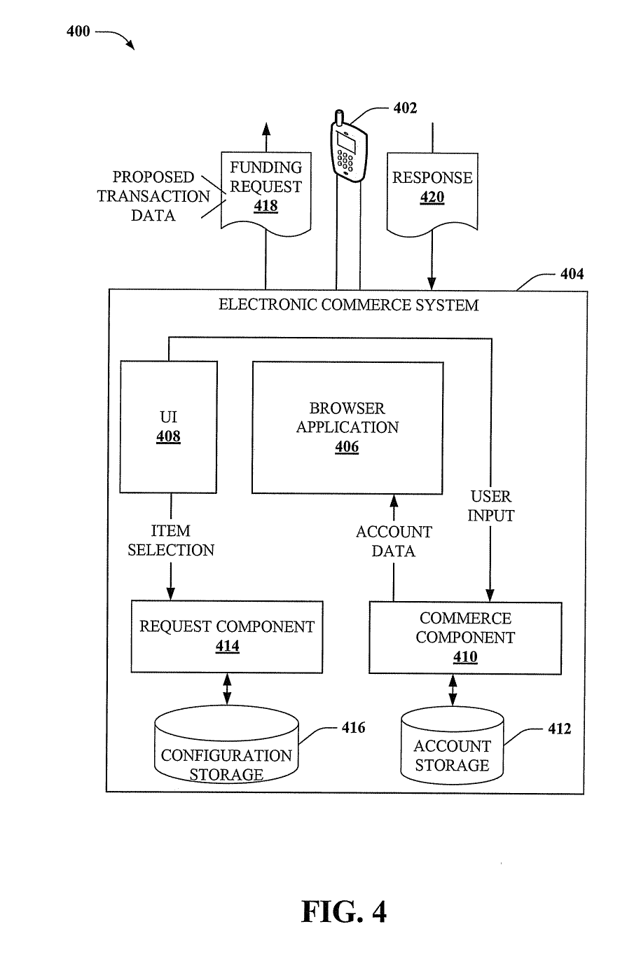

FIG. 4 illustrates a block diagram of an example system 400 configured for making third-party payment requests in conjunction with electronic commerce. System 400 can comprise a requesting mobile terminal 402 comprising an electronic commerce system 404. Electronic commerce system 404 can be implemented in hardware, software, or firmware, or a suitable combination thereof. In addition, electronic commerce system 404 can be modular, having different functions implemented by different components that interact among themselves. Updates to these functions can be implemented independent of, or in conjunction with, related functions, via software/firmware update, hardware update, or the like, or a combination thereof. J

Electronic commerce system 404 can comprise a browser application 406 for displaying content received from an electronic communication. The content can include video, audio, voice, text, multimedia, or other content, or a combination thereof. The content can be output for user consumption via a UI component 408 configured to convert a content message to a suitable user interface component. For instance, UI component 408 can direct video content to be played on a video application, audio content to be played on an audio application, text content to be displayed on a word processor application, and so on. In addition, UI component 408 can be configured to receive a user input associated with selection of an item for an electronic transaction.

User input pertaining to an item selection can be provided to a request component 414. Request component 414 can access configuration data establishing guidelines or rules for requesting third party funding to purchase the selected item. Configuration data can be stored in a configuration storage 416, and can include a set of third-party subscribers to which a request can be made, frequency of such requests, a range of amounts of such requests, a total amount of the requests for a given period (e.g., a maximum amount per month), or the like, or a combination thereof. In at least one aspect, configuration data can be established through a user account interface (not depicted) to a mobile network serving mobile terminal 402. The user account interface can be accessed through a mobile terminal (e.g., mobile terminal 402, a mobile terminal linked with mobile terminal 402 by the mobile network), or a computer Internet connection, or some other suitable network access mechanism.

If configuration requirements for third-party funding are met, request component 414 generates a funding request 418 including information pertaining to the selected item, received from UI 408 or browser application 406. In addition, UI 408 can provide a selection of third party subscribers to which funding request 418 can be sent. In one aspect, a list of third-party subscribers stored on configuration storage 416 can be displayed by UI 408. A user input identifying a selected third-party subscriber can be utilized to address funding request 418 to a selected third-party subscriber.

A response 420 can indicate whether the funding request is approved, denied or being considered. An approval can include an amount of funds to be transferred to an account associated with mobile terminal 402, and a commerce component 410 can update account storage 412 with the amount of funds. To maintain consistency, these accounts are referred to as requesting subscriber accounts, or recipient accounts. However, these accounts are not limited to requesting and receiving funds transfers, and can be utilized to transfer funds to another subscriber account of another mobile terminal, in various aspects of the subject disclosure. Thus, a requesting subscriber account is an intended recipient of a particular funding request, but can also be a third-party subscriber account when used to fund another subscriber's account in response to a funding request from the other subscriber's account.

In a particular aspect, commerce component 410 can limit crediting of funds to a particular account identified in response 420. For instance, if response 420 indicates that a credit of funds are to be exclusively for a Skype account associated with mobile terminal 402, commerce component 410 can require the funds to be credited solely to the Skype account. Commerce component can further restrict an amount of funds of an aggregate number of accounts stored in account storage 412 equal to the credit of funds from being spent on items other than Skype services, for instance. To facilitate actual transactions, commerce component 410 can provide account data (e.g., credit card data, checking account data, credit account data, debit account data, and so on) to an online merchant via browser application 406. Transmission of the account data can effect completion of a particular electronic transaction, as described herein.

According to one or more additional aspects of the subject disclosure, funding request 418 or response 420 can be communicated over a mobile network infrastructure, or can be communicated with peer-to-peer wireless communication. In the former case, funding request 418 or response 420 can be sent as a text message, SMS message, MMS message, or the like. In the latter case, funding request 418 or response 420 can be sent as any suitable peer-to-peer message.

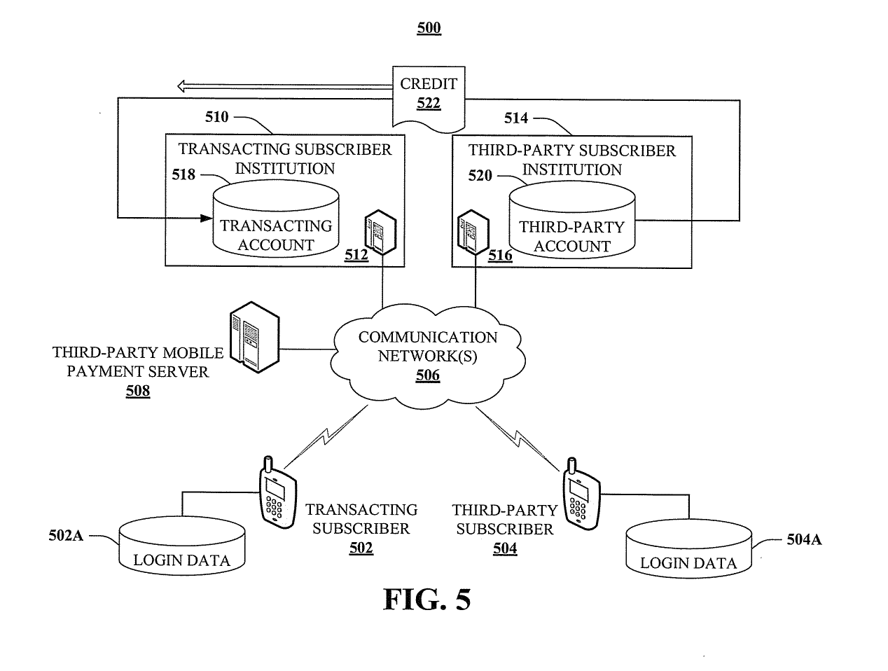

FIG. 5 depicts a block diagram of an example system 500 for facilitating transfer of funds in support of mobile electronic commerce. System 500 can comprise multiple mobile subscriber terminals communicatively connected to a set of communication networks 506. Communication networks 506 include one or more mobile communication networks providing wireless services to respective mobile subscribers. In addition, communication networks 506 can include a public communication network, such as the Internet, private wide area networks, such as a corporate, government or university intranets, and so on, that are directly or indirectly connected to the one or more mobile communication networks. Furthermore, the multiple mobile subscriber terminals include a transacting subscriber terminal 502 and a third-party subscriber terminal 504. In at least one aspect of the subject disclosure, transacting subscriber terminal can be substantially similar to mobile terminal 402 of FIG. 4, infra, whereas third-party subscriber terminal 504 can be substantially similar to mobile terminal 302 of FIG. 3, infra. It should be appreciated that transacting subscriber terminal 502 and third-party subscriber terminal 504 are not limited to these embodiments, however.

System 500 can further comprise a third-party mobile payment server 508 that is configured to facilitate electronic commerce for mobile subscriber terminals 502, 504. More particularly, third-party payment server 508 can be configured to facilitate transfer of funds from one or more financial accounts associated with third-party subscriber terminal 504 to transacting subscriber terminal 502. According to particular aspects of the subject disclosure, the transfer of funds can be implemented in conjunction with an online purchase initiated by transacting subscriber terminal 502, although third-party mobile payment server 508 is not limited to these aspects.

Third-party mobile payment server 508 is communicatively connected to communication networks 506, and through this connection can communicate electronically with transacting subscriber terminal 502, and third-party subscriber terminal 504. Third-party payment server 508 can be physically connected with a service provider's mobile network in at least one aspect of the subject disclosure, enabling communication over the mobile network with transacting subscriber terminal 502 or third-party subscriber terminal 504. In other aspects, third-party payment server 508 can be physically connected to the Internet via a suitable Internet service provider, Internet trunk or Internet backbone connection, or the like, or physically connected to a private intranet that is connected directly or indirectly (e.g., through the Internet) to the service provider's mobile network. Communications with transacting subscriber terminal 502 can include communication related to initiation of an electronic transaction, selection of one or more items provided by an online merchant, or selection of a third-party entity for full or partial payments associated with the electronic transaction. Communication with third-party subscriber terminal 504 can include communications related to facilitating transfer of funds from a financial account associated with third-party subscriber terminal 504 to a financial account associated with transacting subscriber terminal 502.

Further to the above, third-party payment server 508 can be configured to communicate with one or more financial institution servers to negotiate transfer of funds among accounts sponsored or managed by respective financial institutions. Particularly, the one or more financial institution servers can include a communication server 512 of a financial institution associated with transacting subscriber terminal 502 (hereinafter transacting subscriber institution 510), as well as a communication server 514 of a financial institution associated with third-party subscriber terminal 504 (hereinafter third party subscriber institution 514). It should be appreciated that transacting subscriber institution 510 and communication server 512 can be the same as third-party subscriber institution 514 and communication server 516 in one embodiment, or can be independent financial institutions in other embodiments.

At a high level, third-party payment server 508 can be configured to facilitate transfer of funds from a third-party account 520 associated with third-party subscriber 504, to a transacting account 518 associated with transacting subscriber 502. Third-party payment server 508 can be configured to have differing levels of interaction in the funds transfer process, according to particular aspects. In one aspect, third-party payment transfer requests initiated by transacting subscriber 502 can be routed through third-party mobile payment server 508. Third-party mobile payment server 508 can be configured to perform user verification as well as configuration verification on received requests, utilizing data stored in a user/terminal verification database and subscriber configuration profile database (not depicted). User verification can reference user identity information to determine whether the request is indeed submitted by transacting subscriber terminal 502 (e.g., to mitigate or avoid terminal spoofing), or an authorized user thereof (e.g., to mitigate or avoid user impersonation). Similarly, configuration verification can be implemented to determine whether respective third-party payment requests conform to configuration restrictions established for transacting subscriber terminal 502. Suitable configuration restrictions can include limits on an amount of funds requested for transfer, limits on permissible transactions or transaction types, limits on an account or type of account (518) to which funds may be transferred, limits on frequency of third-party payment requests, limits on third-party subscriber terminals 504 for which requests can be submitted, or similar limits, or suitable combinations thereof. Upon completion of user or configuration verification, third-party mobile payment server 508 can forward a request to a designated third-party subscriber terminal 504 identified as a recipient of the request (e.g., identified by mobile number, e-mail address, subscriber profile information, etc.).

Third-party payment server 508 can further be configured to receive a response to a forwarded request from third-party subscriber terminal 504. In similar fashion as described above with a third-party payment request, third-party payment server 508 can be configured to perform user verification or configuration verification on the response (e.g., performing verification as to whether the response is transmitted by an authorized user, or from an authorized terminal, or performing verification as to whether the response conforms to predetermined configuration limits on third-party funds transfers). It should be appreciated that third-party payment server 508 need not be configured for routing payment requests or responses in other disclosed aspects, or for performing user or configuration verification. For instance, in some aspects third-party mobile payment server 508 can be limited to performing only a subset of routing, user verification or configuration verification.

According to further aspects of the subject disclosure, once a third-party request is sent by transacting subscriber terminal 502 and a response approving the request is sent by third-party subscriber terminal 504, third-party mobile payment server 508 can facilitate the transfer of funds approved by the response. Account login data associated with transacting account 518 and stored in a login data store 502A can be forwarded by transacting subscriber terminal 502 to third-party payment server 508. Likewise, account login data associated with third-party account 520 and stored in login data store 504A can be forwarded to third-party mobile payment server 508. Utilizing respective account login data, third-party mobile payment server 508 can communicate with third-party subscriber institution 514 and access third-party account 520. An instruction to transfer funds from third-party account 520 and credit those funds to transacting account 518 can be provided to the subscriber institutions. In response to the instruction, third-party subscriber institution 514 can issue a credit 522 to transacting subscriber institution 510 to be deposited into transacting account 518. A notice of payment and notice of deposit can be provided to third-party mobile payment server 508 from third-party subscriber institution 514 and transacting subscriber institution 510, respectively. Likewise, if transfer of deposit of funds is rejected by either institution, a notice of failure can be provided to third-party mobile payment server 508. Notices of payment and deposit, or notices of rejection can be forwarded to third-party subscriber terminal 504 and transacting subscriber terminal 502.

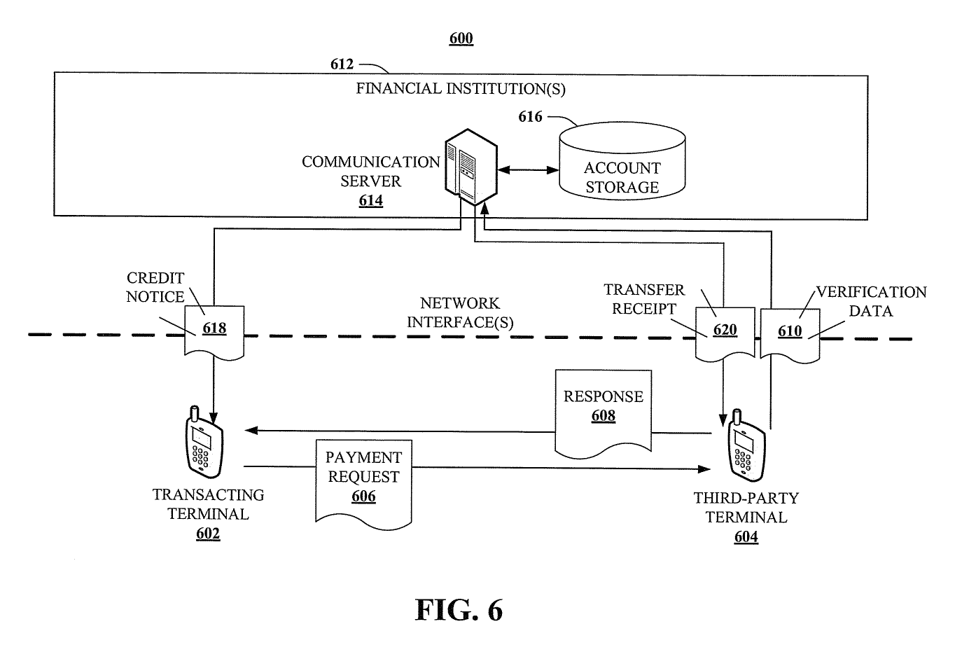

FIG. 6 illustrates a block diagram of a sample system 600 that provides peer-to-peer funds transfers to facilitate third-party payments in electronic commerce according to further aspects of the subject disclosure. System 600 comprises a transacting terminal 602 and a third-party terminal 604 engaged in wireless communication. Wireless communication between transacting terminal 602 and third-party terminal 604 can be conducted via peer-to-peer wireless signaling, or over a mobile network (not depicted), or a suitable combination thereof.

Communication between the terminals comprises a payment request message 606 transmitted from transacting terminal 602 to third-party terminal 604. Payment request message 606 includes a petition for funding an electronic transaction. The electronic transaction can comprise any suitable electronic transaction initiated at transacting terminal 602, or initiated at a computing device (not depicted) associated with a subscriber profile linked with transacting terminal 602 (e.g., a desktop computer having an Internet browser, or private network browser to which a user can log in under the subscriber profile). Payment request message 606 can further comprise information pertaining to the electronic transaction. This latter information can include information pertaining to a good or service selected for purchase, payment associated with the transaction, and information specific to the payment. Examples of suitable payment information can include an amount of funds required for the payment, merchant account information for transferring the payment, schedule, amount and date of periodic payments for recurring payment or for time-based payments, or the like. Additionally, payment request message 606 can comprise information pertaining to an electronic merchant providing the good or service, merchant online ratings, product ratings, or the like. Alternatively, or in addition, a link to a subset(s) of the foregoing information can be provided within payment request message 606.

Upon receiving payment request 606, third-party terminal 604 can wait for user input establishing whether the request will be approved or denied. Additionally, user input could specify that the request is being considered and approval/denial pending review of information linked to or provided within payment request message 606. A response 608 can be transmitted upon receipt of the user input, indicating a status of the approval or denial (or consideration). According to a particular aspect of the subject disclosure, response 608 can be devoid of account information pertaining to a third-party account associated with third-party terminal 604. This can provide privacy for a subscriber of third-party terminal 604. For example, response 608 might simply indicate that ‘x’ amount of money is being transferred to transacting terminal 602. Alternatively, response 608 might indicate a name or alias of an account associated with transacting terminal 602 to which the money is being transferred. According to at least one aspect, the specificity of information as well as content of information provided in response 608 can be configured at third-party terminal 604 (e.g., in preference storage 320 of FIG. 3, supra).

According to one embodiment, depicted by FIG. 6, upon approval of a payment petition, third-party terminal 604 can form an electronic communication link with a communication server 614 of a financial institution 612 over a network interface (e.g., mobile network interface, Internet interface, financial network interface, or suitable combinations thereof—see FIG. 2 as one specific example, supra). Third-party terminal 604 can log into a financial account maintained by financial institution 612 at least in party by transmitting verification data 610 associated with the financial account. Further, third-party terminal 604 can request an amount of funds be transferred from a third-party account associated with third-party terminal 604 to a recipient account associated with transacting terminal 602, to facilitate third-party payment of the electronic transaction identified in payment request message 606. According to various aspects, third-party terminal 604 can identify the recipient account from account information stored at third-party terminal 604, or from information provided in payment request message 606, or via a peer-to-peer query or mobile network-facilitated query to transacting terminal 602 for such information.

Upon receipt of verification data 610, recipient account information and an amount of funds to transfer, communication server 614 can determine whether the third-party account has sufficient unencumbered funds for the transfer (e.g., where unencumbered funds can include funds over and above a minimum deposit amount determine by financial institution 612, above a minimum transfer amount preference stored in account storage 616 and determined by third-party terminal 604, or other suitable requirement). If sufficient funds exist, financial institution 612 can facilitate the transfer of funds from the third-party account to the recipient account. A credit notice 618 is transmitted to transacting terminal 602, indicating the transfer is taking place and optionally when funds associated with the transfer will be available. Additionally, a transfer receipt 620 can be transmitted to third-party terminal 604, documenting the transfer of funds between accounts.

According to an alternative aspect of the subject disclosure, response 608 can include account verification data 610 and information suitable for identifying the third-party account. In at least one specific aspect, response 608 can encrypt or otherwise secure this information to mitigate against unauthorized access to third-party account information. In this aspect, transacting terminal 602 can forward the verification data and third-party account information to financial institution 612 to facilitate the transfer of funds. In such case, communication server 614 can be configured to decrypt or decode the verification data 610 and third-party account information, to verify that transfer of funds is properly authorized by an authorized subscriber or user of the third-party account. If transfer of funds is approved by financial institution 612, as described above, credit notice 618 can then be sent to transacting terminal 602, and a transfer receipt 620 can be sent to third-party terminal 604 as evidence of the transfer of funds.

The aforementioned diagrams have been described with respect to interaction between several components, systems or modules. It should be appreciated that such diagrams can include those components and systems specified therein, some of the specified components/systems, or additional components/systems. For example, a system could include a combination of transacting terminal 602 and electronic commerce system 404, third-party terminal 604 and third-party funding system 304, in conjunction with mobile network 104 and financial institution(s) 612. Sub-components could also be implemented as electrically connected to other sub-components rather than included within a parent architecture. Additionally, it should be noted that one or more disclosed processes could be combined into a single process providing aggregate functionality. For instance, signaling component 310 can comprise transaction component 314 to facilitate facilitating a transfer of account funds and conducting communication related to the transfer, by way of a single component. Components of the disclosed systems can also interact with one or more other components not specifically described herein but known by those of skill in the art.

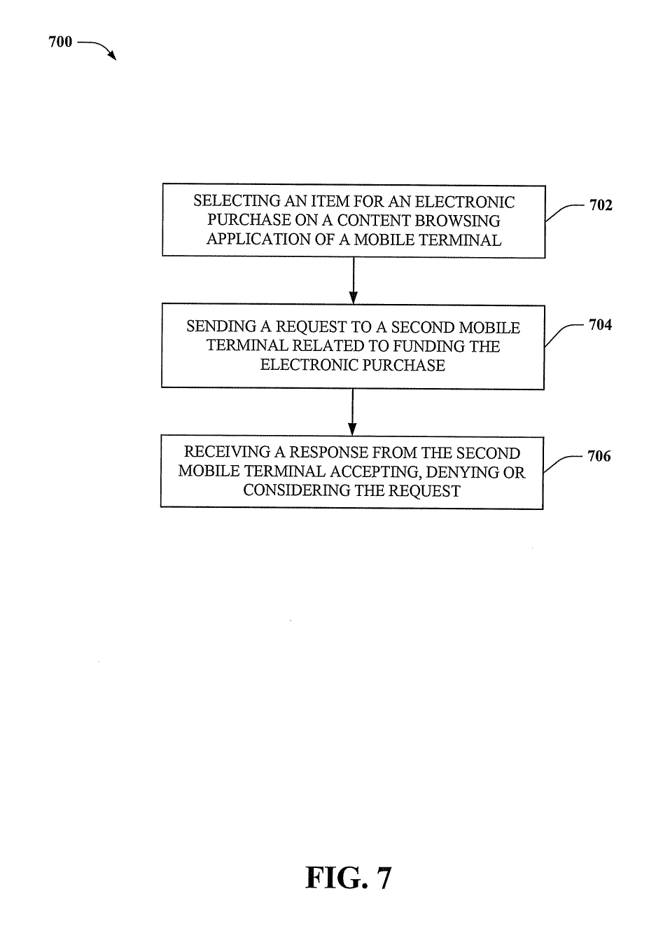

In view of the exemplary diagrams described supra, methods that can be implemented in accordance with the disclosed subject matter will be better appreciated with reference to the flow charts of FIGS. 7-10. While for purposes of simplicity of explanation, the methods 700, 800, 1000 are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods 700, 800, 1000 described hereinafter. Additionally, it should be further appreciated that the methods 700, 800, 1000 disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 7 illustrates a flowchart of an example method 700 for providing third party funding in mobile electronic commerce according to one or more additional aspects of the subject disclosure. At 702, method 700 can comprise selecting an item for an electronic purchase on a content browsing application of a mobile terminal. The selection can comprise including an item in an online shopping cart application, provided by an online merchant website, in one aspect. In another aspect, the selection can comprise copying the item or information related thereto to a shopping cart application maintained on the mobile terminal.

At 704, method 700 can comprise sending a request to a second mobile terminal related to funding the electronic purchase. Further, the request includes information identifying a financial account associated with the mobile terminal in at least one aspect of the subject disclosure. This financial account can be a conventional account accessible through online communication, or an account configured for electronic commerce at last on the content browsing application, or a suitable combination thereof. In a particular embodiment, sending the request can comprise sending a text message, a SMS message, a MMS message, a voice message, or an electronic mail message, or a combination thereof. Further, sending the request can comprise sending voice content, text content, audio content, graphical content, or video content, or a combination thereof, in conjunction with the request. In yet another embodiment, the request can be transmitted to the second mobile terminal with peer-to-peer signaling, or via mobile network facilitating signaling.

Further to the above, at 706, method 700 can comprise receiving a response from the second mobile terminal accepting, denying or considering the request. Receiving the response can comprise receiving voice content, text content, audio content graphical content, or video content, or a suitable combination thereof, in response to the request. Moreover, similar to sending the request, receiving the response can comprise at least in part peer-to-peer communication with the second mobile terminal, in at least one disclosed aspect.

Where the request is approved, method 700 can further comprise receiving a notice of funding for the financial account in response to the request. The notice of funding can be transmitted by the second mobile terminal, or by a financial institution associated with the financial account. Additionally, a subscriber name or alias associated with the second mobile terminal can be identified with the notice of credit. The subscriber name or alias can be provided in lieu of account information from which the credit is drawn, providing privacy for a third-party subscriber.

According to an optional aspect, method 700 can also comprise receiving a notice of credit to the financial account from the financial institution, and an amount of the credit. Method 700 can further comprise expending funds from the financial account equal to or less than the amount of the credit in conjunction with executing the electronic purchase.

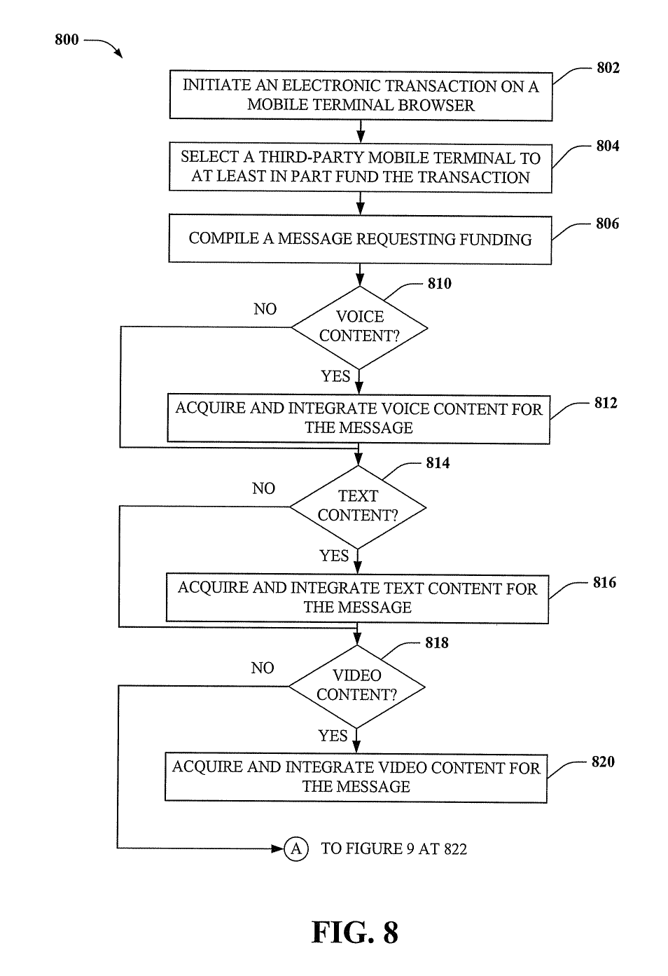

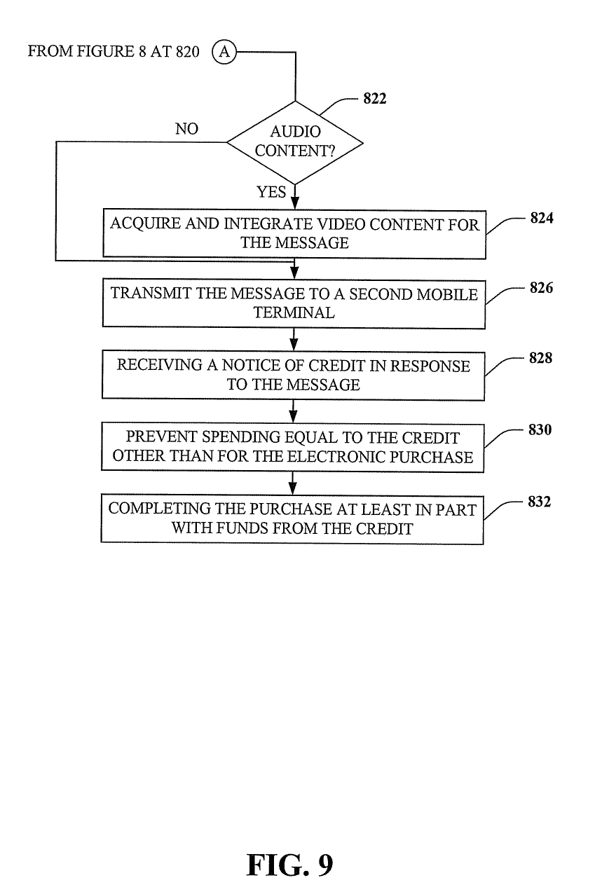

FIGS. 8 and 9 depict a flowchart of an example method 800 for facilitating mobile electronic commerce according to still other aspects of the subject disclosure. At 802, method 800 can comprise initiating an electronic transaction on a mobile terminal browser. At 804, method 800 can comprise selecting a third-party mobile terminal to at least in part fund the transaction. At 806, method 800 can comprise compiling a message requesting funding for the transaction.

At 808, method 800 can determine whether voice content is provided for the message. If so, method 800 proceeds to 812 where voice content is acquired and integrated into the message. Otherwise, method 800 proceeds to 814.

At 814, method 800 can comprise determining whether text content is provided for the message. If so, method 800 proceeds to 816 where text content is acquired and integrated into the message. Otherwise, method 800 proceeds to 818.

At 818, method 800 can comprise determining whether video content is provided for the message. If so, method 800 proceeds to 820 where video content is acquired and integrated into the message. Otherwise, method 800 proceeds to 822.

At 822, method 800 can determine whether audio content is provided for the message. If so, method 800 proceeds to 824 where audio content is acquired and integrated into the message. Otherwise, method 800 proceeds to 826.

At 826, method 800 can comprise transmitting the message to a second mobile terminal. At 828, method 800 can comprise receiving a notice of credit in response to the message. At 830, method 800 can comprise preventing spending equal to the credit on a transaction other than that identified for the electronic purchase in the message requesting funding. Optionally, method 800 can instead comprise limiting spending equal to the credit to only the electronic purchase. At 832, method 800 can comprise completing the purchase at least in part with funds from the notice of credit.

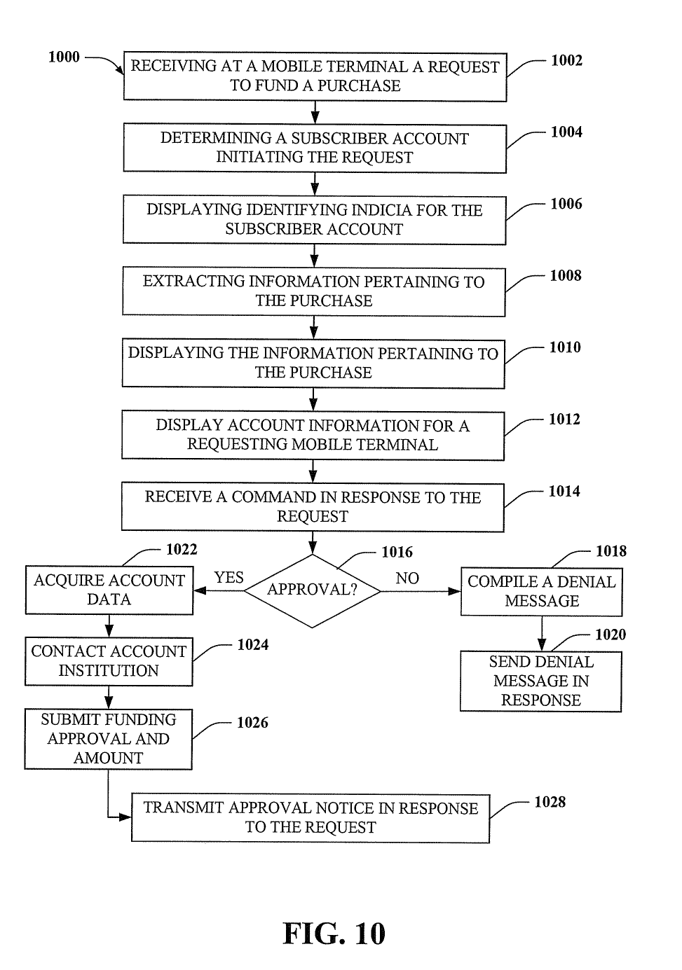

FIG. 10 illustrates a flowchart of a sample method 1000 according to one or more further aspects of the subject disclosure. At 1002, method 1000 can comprise receiving at a mobile terminal a request to fund an electronic purchase. At 1004, method 1000 can comprise determining a subscriber account initiating the request. At 1006, method 1000 can comprise displaying identifying indicia pertaining to the subscriber account. At 1008, method 1000 can comprise extracting information pertaining to the purchase. The information can be extracted from the request, or from a network link included in the request, or a suitable combination thereof. In an alternative embodiment, a query for information pertaining to the request can be transmitted to a requesting mobile terminal, and a response to the request received at the mobile terminal, wherein at least a subset of the information is extracted from the response. At 1010, method 1000 can comprise displaying at least a subset of the information pertaining to the purchase. At 1012, method 1000 can comprise displaying account information of one or more recipient accounts associated with the requesting mobile terminal. At 1014, method 1000 can comprise receiving a command in response to the request. The command can include user input approving or denying the request, in at least one aspect. Additionally, the command include user input identifying a recipient account for transferring funds, and an amount of funds, in the event the user input approves the request.

At 1016, method 1000 can comprise determining whether approval is included with the user input. If not, method 1000 can proceed to reference number 1018, and can compile a denial message for the request. At 1020, method 1000 can send the denial message in response to the request.

If at 1016, method 1000 determines that approval is included with the user input, method 1000 can proceed to 1022, and can acquire account data pertaining to a recipient user account. Account data can be acquired from the request, in one aspect of the subject disclosure. In another aspect, account data can be acquired from a data storage comprising recipient account information. In yet another aspect, account data can be acquired in response to a query for such data transmitted to the mobile terminal, wherein the mobile terminal provides the account information in the response. Optionally, the account information can be encrypted or otherwise secured in the response to mitigate or prevent unauthorized access to the account information, or unauthorized receipt of the account information.

In addition to the foregoing, at 1024, method 1000 can comprise contacting a financial institution associated with an account identified by the account data. At 1026, method 1000 can comprise submitting funding approval and an amount of funding to be transferred to the account from a third-party account. At 1028, method 1000 can comprise transmitting an approval notice in response to the request to the mobile terminal.

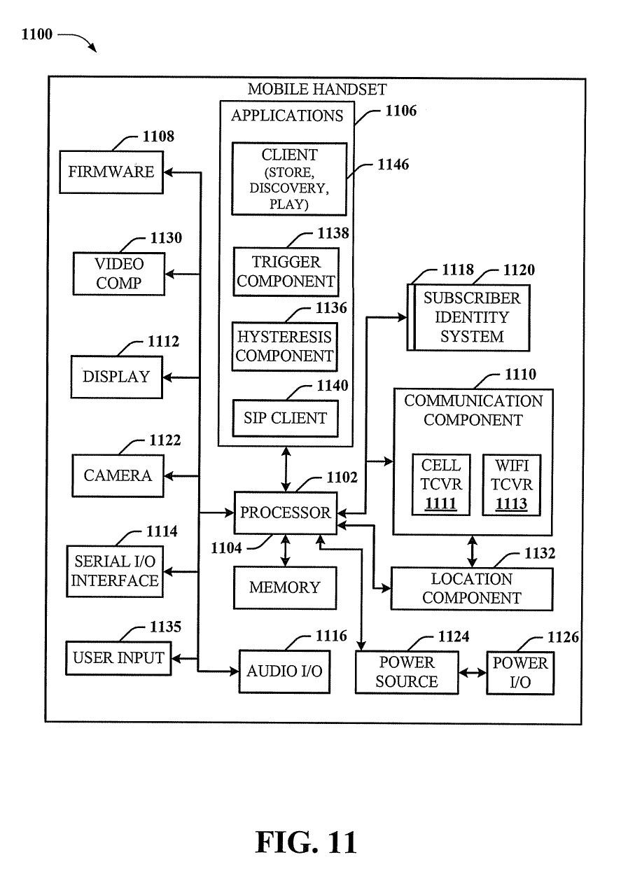

Referring now to FIG. 11, illustrated is a schematic block diagram of an exemplary mobile device 1100 capable of requesting or providing third-party funding for electronic commerce initiated by mobile device 1100 or another device, in accordance with some embodiments described herein. Although a mobile handset 1100 is illustrated herein, it will be understood that other devices can be a mobile device, and that the mobile handset 1100 is merely illustrated to provide context for the embodiments of the innovation described herein. The following discussion is intended to provide a brief, general description of an example of a suitable environment 1100 in which the various disclosed embodiments can be implemented. While the description includes a general context of computer-executable instructions embodied on a computer readable storage medium, those skilled in the art will recognize that the innovation also can be implemented in combination with other program modules or as a combination of hardware, software or firmware.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices. Further, illustrated aspects of the subject disclosure can be practiced in distributed computing environments where certain tasks are performed by remote processing devices that are linked through a communications network (e.g., multiple mobile handsets 1100 communicating with peer-to-peer signaling, or through a mobile communication network). In a distributed computing environment, systems and system components, as well as program modules can be located in both local and remote memory storage devices (e.g., third-party funding system 304 located remotely from electronic commerce system 404).

A computing device such as mobile handset 1100 can typically include a variety of media, which can include computer-readable storage media or communication media, which two terms are used herein differently from one another as follows.

Computer readable storage media can be any available storage media that can be accessed by a computer (e.g., mobile handset 1100) and includes both volatile and nonvolatile media, removable and non-removable media. By way of example and not limitation, computer-readable storage media can be implemented in connection with any method or technology for storage of information, such as computer-readable instructions, data structures, program modules or unstructured data. Computer-readable storage media can include, but is not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible or non-transitory media which can be used to store desired information. Computer-readable storage media can be accessed by one or more local or remote computing devices, e.g., via access requests, queries or other data retrieval protocols, for a variety of operations with respect to the information stored by the medium.

Communication media typically embodies computer-readable instructions, data structures, program modules or other structured or unstructured data in a modulated data signal such as a carrier wave or other transport mechanism, and includes any suitable information delivery or transport media. The term “modulated data signal” or signals means a signal that has one or more of its characteristics set or changed in such a manner as to encode information in one or more signals. By way of example, and not limitation, communication media includes wired media such as a wired network or direct-wired connection, and wireless media such as acoustic, RF, infrared and other wireless media.

Mobile handset 1100 includes a processor 1102 for controlling and processing onboard operations and functions. A memory 1104 interfaces to the processor 1102 for storage of data and one or more applications 1106 (e.g., a video player software, user feedback or user input component software, etc.). Other applications can include voice recognition of predetermined voice commands that facilitate receipt of user input. The applications 1106 can be stored in the memory 1104 and/or in a firmware 1108, and executed by the processor 1102 from either or both the memory 1104 or the firmware 1108. The firmware 1108 can also store startup code for execution in initializing mobile handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) or an unlicensed transceiver 1113 (e.g., WiFi, WiMAX) for corresponding signal communications. Mobile handset 1100 can be a device such as a cellular telephone, a PDA with mobile communications capabilities, and messaging-centric devices. The communications component 1110 also facilitates communications reception from terrestrial radio networks (e.g., broadcast), digital satellite radio networks, and Internet-based radio services networks.

Mobile handset 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor 1102 to facilitate wired and/or wireless serial communications (e.g., USB, and/or IEEE 1194) through a hardwire connection, and other serial input devices (e.g., a keyboard, keypad, and mouse). This supports updating and troubleshooting mobile handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

Mobile handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software.

The handset 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the handset 1100 and IP-based multimedia content can be received in either an encoded or decoded format.

A graphics processing component 1122 (e.g., a camera) can be provided for decoding encoded multimedia content. The graphics processing component 1122 can aid in facilitating the generation, playback, editing and sharing of graphical quotes. Mobile handset 1100 also includes a power source 1124 in the form of batteries and/or an AC power subsystem, which power source 1124 can interface to an external power system or charging equipment (not shown) by a power I/O component 1126.

Mobile handset 1100 can also include a video component 1130 for processing video content received and, for recording and transmitting video content. For example, the video component 1130 can facilitate the generation, editing and sharing of video quotes. A location tracking component 1132 facilitates geographically locating mobile handset 1100. A user input component 1134 facilitates the user inputting information, responses or selections into mobile handset 1100. The user input component 1134 can include such conventional input device technologies such as a keypad, keyboard, mouse, stylus pen, or touch screen, for example. Information provided to user input component 1134 can be used for approving or denying a third-party funding request, identifying or selecting an account to which or from which funds are transferred, or sending messaging content in conjunction with a request for funding or response to such a request.

Referring again to the applications 1106, a hysteresis component 1136 facilitates the analysis and processing of hysteresis data, which is utilized to determine when to associate with an access point. A software trigger component 1138 can be provided that facilitates triggering of the hysteresis component 1138 when the WiFi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

Mobile handset 1100, as indicated above related to the communications component 1110, includes an indoor network radio transceiver 1113 (e.g., WiFi transceiver). This function supports the indoor radio link, such as IEEE 802.11, in the event mobile handset 1100 comprises a dual-mode GSM handset. Mobile handset 1100 can accommodate at least satellite radio services through a handset that can combine wireless voice and digital radio chipsets into a single handheld device.

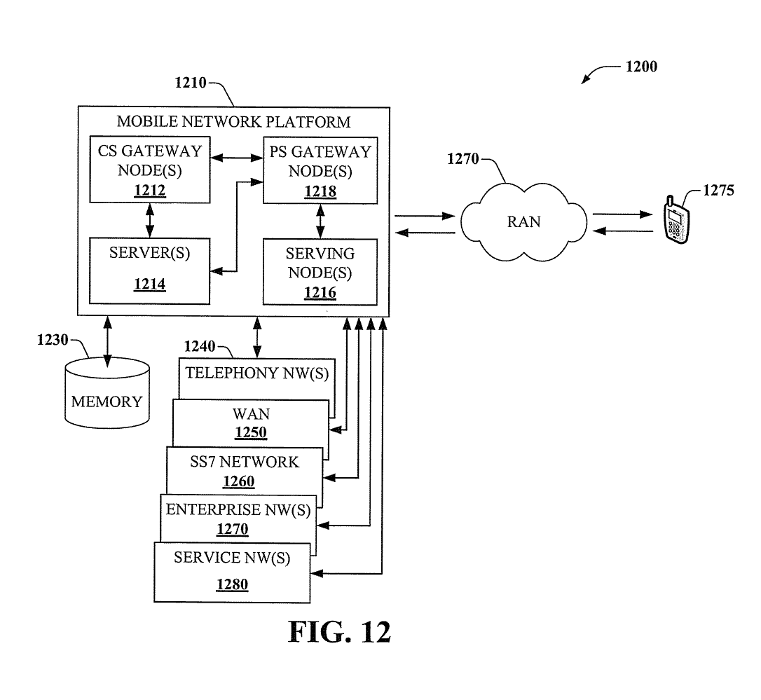

FIG. 12 presents an example embodiment 1200 of a mobile network platform 1210 that can implement and exploit one or more aspects of the disclosed subject matter described herein. Generally, wireless network platform 1210 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. Mobile network platform 1210 includes CS gateway node(s) 1212 which can interface CS traffic received from legacy networks like telephony network(s) 1240 (e.g., public switched telephone network (PSTN), or public land mobile network (PLMN)) or a signaling system #7 (SS7) network 1270. Circuit switched gateway node(s) 1212 can authorize and authenticate traffic (e.g., voice) arising from such networks. Additionally, CS gateway node(s) 1212 can access mobility, or roaming, data generated through SS7 network 1270; for instance, mobility data stored in a visited location register (VLR), which can reside in memory 1230. Moreover, CS gateway node(s) 1212 interfaces CS-based traffic and signaling and PS gateway node(s) 1218. As an example, in a 3GPP UMTS network, CS gateway node(s) 1212 can be realized at least in part in gateway GPRS support node(s) (GGSN). It should be appreciated that functionality and specific operation of CS gateway node(s) 1212, PS gateway node(s) 1218, and serving node(s) 1216, is provided and dictated by radio technology(ies) utilized by mobile network platform 1210 for telecommunication.

In the disclosed subject matter, in addition to receiving and processing CS-switched traffic and signaling, PS gateway node(s) 1218 can authorize and authenticate PS-based data sessions with served mobile devices. Data sessions can include traffic, or content(s), exchanged with networks external to the wireless network platform 1210, like wide area network(s) (WANs) 1250, enterprise network(s) 1270, and service network(s) 1280, which can be embodied in local area network(s) (LANs), can also be interfaced with mobile network platform 1210 through PS gateway node(s) 1218. It is to be noted that WANs 1250 and enterprise network(s) 1260 can embody, at least in part, a service network(s) like IP multimedia subsystem (IMS). Based on radio technology layer(s) available in technology resource(s) 1217, packet-switched gateway node(s) 1218 can generate packet data protocol contexts when a data session is established; other data structures that facilitate routing of packetized data also can be generated. To that end, in an aspect, PS gateway node(s) 1218 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1200, wireless network platform 1210 also includes serving node(s) 1216 that, based upon available radio technology layer(s) within technology resource(s) 1217, convey the various packetized flows of data streams received through PS gateway node(s) 1218. It is to be noted that for technology resource(s) 1217 that rely primarily on CS communication, server node(s) can deliver traffic without reliance on PS gateway node(s) 1218; for example, server node(s) can embody at least in part a mobile switching center. As an example, in a 3GPP UMTS network, serving node(s) 1216 can be embodied in serving GPRS support node(s) (SGSN).

For radio technologies that exploit packetized communication, server(s) 1214 in wireless network platform 1210 can execute numerous applications (e.g., location services, online gaming, wireless banking, wireless device management . . . ) that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1210. Data streams (e.g., content(s) that are part of a voice call or data session) can be conveyed to PS gateway node(s) 1218 for authorization/authentication and initiation of a data session, and to serving node(s) 1216 for communication thereafter. In addition to application server, server(s) 1214 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1210 to ensure network's operation and data integrity in addition to authorization and authentication procedures that CS gateway node(s) 1212 and PS gateway node(s) 1218 can enact. Moreover, provisioning server(s) can provision services from external network(s) like networks operated by a disparate service provider; for instance, WAN 1250 or Global Positioning System (GPS) network(s) (not shown). Provisioning server(s) can also provision coverage through networks associated to wireless network platform 1210 (e.g., deployed and operated by the same service provider), such as Femto cell network(s) (not shown) that enhance wireless service coverage within indoor confined spaces and offload RAN resources in order to enhance subscriber service experience within a home or business environment. Server(s) 1214 can embody, at least in part, ticketing priority system 602 and database 104, as well as various other component(s) disclosed herein

It is to be noted that server(s) 1214 can include one or more processors configured to confer at least in part the functionality of macro network platform 1210. To that end, the one or more processor can execute code instructions stored in memory 1230, for example. It is should be appreciated that server(s) 1214 can include a content manager 1215, which operates in substantially the same manner as described hereinbefore.

In example embodiment 1200, memory 1230 can store information related to operation of wireless network platform 1210. In particular, memory 1230 can include contents of memory 604 in example system 600. Other operational information can include provisioning information of mobile devices served through wireless platform network 1210, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1230 can also store information from at least one of telephony network(s) 1240, WAN 1250, enterprise network(s) 1260, or SS7 network 1270.

It is to be noted that aspects, features, or advantages of the disclosed subject matter described in the subject specification can be exploited in substantially any wireless communication technology. For instance, Wi-Fi, WiMAX, Enhanced GPRS, 3GPP LTE, 3GPP2 UMB, 3GPP UMTS, HSPA, HSDPA, HSUPA, GERAN, UTRAN, LTE Advanced. Additionally, substantially all aspects of the disclosed subject matter as disclosed in the subject specification can be exploited in legacy telecommunication technologies; e.g., GSM. In addition, mobile as well non-mobile networks (e.g., internet, data service network such as internet protocol television (IPTV)) can exploit aspects or features described herein.

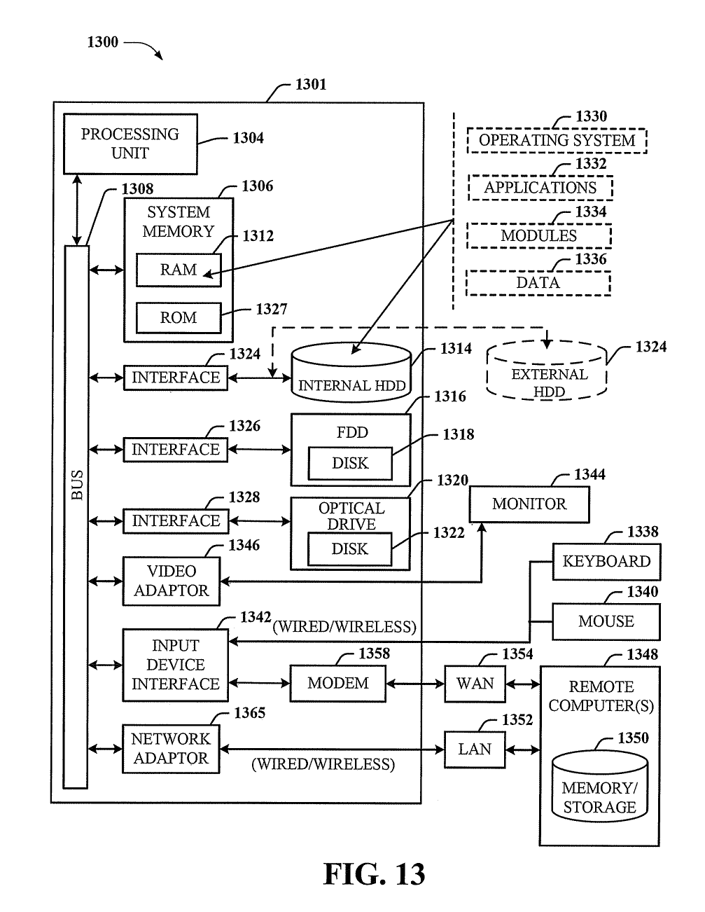

With reference to FIG. 13, an exemplary environment 1300 for implementing various aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 can also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1311 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 2394 serial port, a game port, a USB port, an IR interface, etc.

A monitor 1344 or other type of display device is also connected to the system bus 1308 through an interface, such as a video adapter 1346. In addition to the monitor 1344, a computer typically includes other peripheral output devices (not shown), such as speakers, printers, etc.

The computer 1302 can operate in a networked environment using logical connections by wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or can be connected to a communications server on the WAN 1354, or has other means for establishing communications over the WAN 1354, such as by way of the Internet. The modem 1358, which can be internal or external and a wired or wireless device, is connected to the system bus 1308 through the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11 (a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What is claimed is:

1. A system that facilitates third party electronic payments in conjunction with a mobile communication network, comprising:
a communication interface configured to receive a funding request from a requesting subscriber profile, wherein the funding request includes information about a desired electronic transaction and a petition to a third party subscriber profile for funding associated with the electronic transaction;
a signaling component configured to notify the third party subscriber profile of the funding request; and
a transaction component configured at least to facilitate providing electronic funds to the requesting subscriber profile in response to the funding request.

2. The system of claim 1, further comprising a security component configured to mask account information related to the third party subscriber profile from the requesting subscriber profile or from a merchant account associated with the electronic transaction.

3. The system of claim 2, wherein the security component is further configured to allow provision of the account information to an entity sponsoring or managing a funding account that is linked to the third party subscriber profile and from which the electronic funds are withdrawn, in conjunction with masking the account information from the requesting subscriber profile or from the merchant account.

4. The system of claim 1, wherein the transaction component is further configured to facilitate selection, via the third party subscriber profile, of a funding account associated with the third party subscriber profile for providing the electronic funds.

5. The system of claim 4, wherein the one or more accounts associated with the third party subscriber profile comprises a checking account, a debit account, a credit account, a savings account, or an investment account, or a combination thereof.

6. The system of claim 4, wherein the transaction component is further configured to receive specification of an amount of funds input via the third party subscriber profile in response to the funding request, and account information for the selected funding account.

7. The system of claim 6, wherein the transaction component is further configured to communicate electronically with an entity sponsoring or managing the selected funding account and to acquire the amount of funds, a payment assurance thereof, or a denial of payment of the amount of funds.

8. The system of claim 7, wherein the transaction component is further configured to credit a financial account associated with the requesting subscriber profile in response to acquiring the amount of funds or payment assurance thereof.

9. The system of claim 8, wherein crediting the financial account is conducted electronically at least in part over the mobile communication network.

10. The system of claim 8, wherein crediting the financial account is conducted electronically at least in part via peer-to-peer communication between a wireless communication device associated with the requesting subscriber profile and a wireless communication device associated with the third part subscriber profile.

11. The system of claim 1, wherein notifying the third party subscriber profile of the funding request is conducted at least in part via peer-to-peer communication between a wireless communication device associated with the requesting subscriber profile and a wireless communication device associated with the third party subscriber profile.

12. The system of claim 1, wherein the transaction component is further configured to identify to the third party subscriber profile one or more recipient accounts associated with the requesting subscriber profile to which the electronic funds can be provided.

13. The system of claim 12, wherein the transaction component is further configured to enable selection of a target account of the one or more recipient accounts.

14. The system of claim 13, wherein the transaction component is further configured to restrict transfer of electronic funds to other than the target account for the funding request in response to the selection.

15. The system of claim 1, wherein the signaling component is further configured to receive a response from the third party subscriber profile acknowledging the funding request.

16. The system of claim 15, wherein the response includes accepting, rejecting or considering the funding request, and wherein the signal component is further configured to update the requesting subscriber profile with a status of the response.

17. The system of claim 16, wherein the signaling component is further configured to update a merchant account associated with the electronic transaction with the status.

18. The system of claim 1, further comprising a messaging component configured to receive a message from the requesting subscriber account at the third party subscriber account in conjunction with the notifying the third party subscriber account of the funding request.

19. The system of claim 18, wherein the message comprises a text message, a short message service (SMS) message, or a multimedia message service (MMS) message, or a combination thereof.

20. The system of claim 18, wherein content of the message comprises text content, audio content, voice content, or video content, or a combination thereof.

21. The system of claim 18, wherein the messaging component is further configured to exchange a set of messages pertaining to the funding request between the requesting subscriber profile and the third party subscriber profile.

22. The system of claim 21, wherein the messaging component is further configured to conduct the exchange of the set of messages via peer-to-peer communication or via the mobile communication network.

23. A method of electronic commerce in wireless networks, comprising:
selecting an item for an electronic purchase on a content browsing application of a mobile terminal;
sending a request to a second mobile terminal related to funding the electronic purchase; and
receiving a response from the second mobile terminal accepting, denying or considering the request, wherein the request includes information identifying a financial account associated with the mobile terminal that is configured for electronic commerce at least on the content browsing application.

24. The method of claim 23, further comprising receiving a notice of funding for the financial account at the mobile terminal in response to the request.

25. The method of claim 24, wherein a subscriber name or alias associated with the second mobile terminal is identified with the notice of the credit in lieu of account information from which the credit is drawn.

26. The method of claim 23, further comprising receiving, in response to the request, a notice of a credit to the financial account and an amount of the credit.

27. The method of claim 26, further comprising expending funds from the financial account equal to or less than the amount of the credit in conjunction with executing the electronic purchase.

28. The method of claim 26, further comprising preventing an expenditure from the financial account equal to or less than the amount of the credit for a purchase other than the electronic purchase.

29. The method of claim 23, wherein sending the request further comprises sending a text message, a voice message, a short message service message, a multimedia service message or an electronic mail message, or a combination thereof, from the mobile terminal to the second mobile terminal.

30. The method of claim 23, further comprising sending voice content, text content, audio content or video content, or a combination thereof, in conjunction with the request.

31. The method of claim 23, further comprising receiving voice content, text content, audio content or video content, or a combination thereof, in response to the request.

32. The method of claim 23, wherein sending the request or receiving the response at least in part involves a peer-to-peer communication with the second mobile terminal.

33. A processor and related memory that stores instructions configured to, when executed by the computer processor, facilitate third-party electronic commerce, the instructions comprising:
initiating an electronic transaction on a wireless device for an item provided by an electronic merchant entity;
requesting at least partial funding for the electronic transaction from a third party mobile subscriber account; and
receiving a credit from the third party mobile subscriber account at least in part at the wireless device in conjunction with funding the electronic transaction.

34. A system that facilitates third-party electronic commerce, comprising:
means for receiving a request for funds from a dependent subscriber account pertaining to an electronic purchase selected by the dependent subscriber account;
means for acquiring transaction details pertaining to the electronic purchase;
means for accepting or denying the request for funds; and
means for providing electronic monetary credit to a financial account associated with the dependent subscriber account, wherein the means for providing electronic monetary credit masks account information of a funding account from the dependent subscriber account or from a merchant entity associated with the electronic purchase.
